(19) United States
(12) Patent Application Publication
(10) Pub. No.: US 2007/0131036 A1
(43) Pub. Date: Jun. 14, 2007

(54) METHOD FOR DETERMINING A WEB TENSION

(76) Inventor: Stephan Schultze, Lohr am Main (DE)

Correspondence Address: STRIKER, STRIKER & STENBY, 103 EAST NECK ROAD, HUNTINGTON, NY, 11743, US

(21) Appl. No.: 11/566,999

(22) Filed: Dec. 5, 2006

(30) Foreign Application Priority Data
Dec. 9, 2005 (DE) 10 2005 058 810.7

(51) Int. Cl. B65H 77/00; G01L 5/04; G01L 5/10

(52) U.S. Cl. 73/862.391; 242/410; 702/43

(57) ABSTRACT

A method of determining a web tension of at least one second web tension section in a product web having at least two web tension sections includes determining a web tension on at least one first web tension section, and determining a web tension of the at least one second web tension section on the basis of the web tension determined on the at least one first web tension section.

### CROSS-REFERENCE TO A RELATED APPLICATION

The invention described and claimed hereinbelow is also described in German Patent Application DE 10 2005 058 810.7 filed on Dec. 9, 2005. This German Patent Application, whose subject matter is incorporated here by reference, provides the basis for a claim of priority of invention under 35 U.S.C. 119(a)-(d).

### BACKGROUND OF THE INVENTION

The present invention relates to a method for determining a web tension.

There exist various devices or machines in which a product web is processed in individual product web sections with associated web tensions. The regulation of the web tension of a product web is a complex procedure in which a large number of variables are involved. In order to regulate the web tension to a predefined desired value, the knowledge of an instantaneous actual value is required.

Processing machines in which product webs are subdivided into sections of various web tension are primarily found in the area of paper, paperboard, plastic films and metal foils. In these machines, as it passes through the machine, the product web is subdivided into at least two sections, the intention being for each section to have a predetermined web tension value.

In the prior art, for this purpose the web tension in each section is measured by means of suitable web tension sensors and regulated to the desired value by means of influencing the machine appropriately. For instance, the speeds of the transport axles are changed in such a way that the web tension in each section follows the respective desired value. To this end, web tension control systems are known, for example the SYNAX system, which has such a function for web tension regulation.

EP 0 914 944 discloses a tension regulating system having a plurality of tension detectors, which are arranged on the upstream sides of press cylinders and on the upstream sides of tensioning rolls, in order to detect tensions on a web appropriately, speed setting means being provided for setting corresponding rotational speeds of the press cylinders and the tensioning rolls on the basis of output signals from controllers, to which detected values from corresponding tension detectors are fed back, tension setting devices being assigned to the controllers and the controllers comparing the values detected by the tension detectors and desired values from the tension setting devices with one another and outputting the output signals for the regulation of the rotational speeds of the press cylinders and the tensioning rolls, in order to reduce the compared values appropriately to zero.

Since the adjustment of one drive axle acts on the web tension of a plurality of sections, for example the SYNAX system has the possibility of arranging for an actuating axle to be controlled by two web tension control systems. This means that the web tension control of one section is able to adjust both the previous and the following transport axle in order not to influence the web tension in the adjacent sections during control processes in this section. Depending on the time constant of the control systems, oscillatory processes can occur as a result.

In the aforementioned prior art, for each web tension section, an individual measuring device is therefore provided; in addition, it is not possible to completely avoid influencing the tension adjustments of the individual sections among one another.

### SUMMARY OF THE INVENTION

The object is therefore set of specifying an improved method for determining a web tension which does not exhibit the aforementioned problems.

According to the invention, therefore, a method for determining a web tension and also a corresponding computing unit, a computer program and a computer program product having the features of the independent patent claims are presented. Advantageous refinements form the subject of the subclaims and the following description.

In the method for determining a web tension of at least one second web tension section in a product web having at least two web tension sections, the web tension of at least one first web tension section is determined first. The web tension of the at least one second web tension section is then determined on the basis of the web tension determined on the at least one first web tension section. At this point, it should be made clear that the web tension of the at least one second web tension section is in particular not measured.

With the solution according to the invention, a large number of measuring sensors for determining the web tension can advantageously be saved. Depending on the embodiment of the invention, all the measuring devices or all except one measuring device can be saved. Therefore, a considerable saving in costs and material is possible, since the remaining web tension values are determined by means of computation or estimation. The method according to the invention can very advantageously be used in conjunction with a web tension control system. The values obtained are expediently compared with desired web tension values that are provided, and the web tension is then regulated appropriately. Furthermore, the mutual influence can advantageously be reduced. If, in the solution according to the invention, the different web tension controllers automatically receive changes in the preceding web tension sections early via a feedforward control system, the compensation processes are substantially shorter.

The web tension of the at least one first web tension section is advantageously measured. For this purpose, for example, a measuring roll and a pressure capsule can be used, as is known in the prior art. Therefore, absolute web tension values are determined, which can be used to determine the remaining web tension values.

According to a preferred refinement of the solution according to the invention, the web tension of the at least one first web tension section is determined while taking into account a modulus of elasticity of the product web material and a rotational speed of at least two transport axles. In addition, an absolute web tension value is also therefore determined, which can be used to determine the remaining web tension values. Under the assumption of slip-free transport, the web tension value S1 in the at least one first web tension section between two transport axles having the rotational speeds n1 and n2, taking the modulus of elasticity E of the product web material into account, is calculated to be S1=E.n2−n1/n1, the transport being carried out from the transport axle or roll having the rotational speed n1 in the direction of the transport axle having the rotational speed n2. The term n2−n1/n1 describes an elongation d.

According to a likewise preferred refinement of the solution according to the invention, the web tension of the at least one first web tension section is determined while taking into account a known web tension value, in particular by means of a dancer by using the web tension value impressed by the dancer, and a drive torque of at least one transport axle. An absolute web tension value is also therefore determined, which can be used to determine the remaining web tension values. For example, in order to determine a web tension S1 while taking into account the known web tension S0, the drive torque N of the transport axle between the sections having the web tensions S0 and S1 is taken into account.

The drive torque N can typically be determined in the case of a machine. It can be read, for example, from the drive or from the draw control system. From the drive torque N, preferably via the diameter D (lever rule), it is possible to draw conclusions about the force F1=2N/D changing the web tension and, from that, about the web tension F1 fed in. S1 is then calculated to be S1=S0−F1. If the drive is working in the motor range (positive drive torque), the web tension in section 1 will be lower than in section 0. If it is working in generator operation (negative drive torque), the web tension in section 1 will be higher than in section 0.

It is expedient if, in the method according to the invention, the web tension of the at least one second web tension section is determined by using a rotational speed of at least two transport axles. If the web tension S1 is known in one section, by using the rotational speeds of the transport axles delimiting the web section, it is possible to draw conclusions about the modulus of elasticity. If this constant of the product web is not changed (for example by processing), then in another section it is possible to draw conclusions about the web tension S2 contained therein. For this purpose, the moduli of elasticity in the two sections are set equal. Therefore, a web tension value S2 of the at least one second web tension section is determined on the basis of the web tension value S1 of the first web tension section. Via the rotational speeds of the transport axles involved, the elongations d1 and d2 of the sections are obtained as described further above. From these,

$$S 2 = S 1 \cdot \frac{ⅆ 2}{ⅆ 1}$$

is determined.

It is expedient if, in the method according to the invention, changes in an elongation property, in particular a modulus of elasticity, of the product web are taken into account. The modulus of elasticity is typically changed by processing the web. If this change is known, this can be taken into account when determining the web tension. The accuracy of the method can be increased thereby.

According to an advantageous development of the invention, for the modulus of elasticity, a second cross section of the product web in another web tension section that differs from a first cross section of the product web in a web tension section is taken into account linearly by using the ratio of the first to the second cross section. If, for example as a result of processing the web, its cross section changes, for example as a result of trimming the edge or punching out material, then the modulus of elasticity will change accordingly. If, for example, the cross section of the product web is reduced, the modulus of elasticity will also decrease. As an approximation in this case, a linear relationship between product web width or cross section A and modulus of elasticity E can be assumed. If the cross section is changed from A1 to A2, the modulus of elasticity changes from E1 to

$$E 2 = E 1 \cdot \frac{A 2}{A 1} .$$

. Thus, the web tension S2 in the web tension section having the cross section A2 is given by

$$S 2 = S 1 \cdot \frac{ⅆ 2}{ⅆ 1} \cdot \frac{A 2}{A 1} .$$

The accuracy of the method can be increased thereby.

It is advantageous if, in the invention, a slip of the transport axles is taken into account by estimating the slip. Likewise advantageously, the slip of the transport axles is taken into account by measuring the slip. If the transport is not completely slip-free (e.g. as a result of opposing pressure rolls which are not set firmly against each other), then, given knowledge of this slip, the latter can also be incorporated in the determination of the rotational speed relationships. In this case, this slip cannot be determined automatically but must be estimated or measured, for example by means of a measuring wheel. The accuracy of the method can be increased thereby.

In the method according to the invention, the web tension of the at least one second web tension section is preferably determined by using a drive torque of at least one transport axle.

According to a preferred development of the method according to the invention, the drive torque is converted by means of a lever rule into a force changing the web tension, by using a diameter of the at least one transport axle.

In the invention, in particular when determining the force changing the web tension, a frictional torque of the at least one transport axle is expediently taken into account. The frictional torque can be taken into account, for example, as the sum of a constant value and a speed-dependent or rotational speed-proportional value or another predefinable rotational speed-dependent characteristic curve. In this case, the compensation values can be determined simply by means of a manual, partly automated or fully automated measuring run without a product web. The accuracy of the web tension determination can be increased thereby.

Likewise expediently, in the method according to the invention, a processing torque of a processing axle within a web tension section is also taken into account. In this way, a tension to be determined can be determined more accurately. It is recommended to take the processing torque into account with a constant and a rotational speed-proportional component. This refinement permits in particular the use of a simple computational model.

Expediently, in the invention a measurement of the drive torques is carried out by means of filtering of the measured torques, the frictions determined and/or the processing forces. By using this, smoothing of web tension values determined over time, and thus the ability to further process the values determined, can easily be achieved.

Expediently, in the invention, during a measurement of the drive torques, a calibration of drive data, in particular a torque constant of the motor, is taken into account. The accuracy of the method according to the invention for determining a web tension can be improved hereby.

Expediently, in the invention, the drive data is determined by using a manual, partly automated or fully automated measuring run. In this way, the ease of handling of the method and system according to the invention is improved for a user.

Expediently, in the invention, field-weakening operation of a motor is taken into account of the determination of the drive torque. Taking this into account likewise increases the accuracy of the method according to the invention.

A computing unit according to the invention determines the web tension of the at least one second web tension section on the basis of the web tension determined in the first web tension section in accordance with the method according to the invention.

A computer program according to the invention contains program code means in order to determine the web tension of the at least one second web tension section on the basis of the web tension determined in the first web tension section in accordance with the method according to the invention, if the computer program is executed on a computer or a corresponding computing unit, in particular one of the computing units according to the invention.

A computer program product according to the invention includes program code means which are stored on a computer-readable data storage medium, in order to determine the web tension of the at least one second web tension section on the basis of the web tension determined in the first web tension section in accordance with the method according to the invention, if the computer program product is executed on a computer or on a corresponding computing unit, in particular one of the computing units according to the invention. Suitable data storage media are, in particular, floppy disks, hard disks, flash memories, EEPROMs, CD-ROMs and many others. A download of a program via computer networks (Internet, intranet and so on) is also possible.

The solution according to the invention is preferably used in conjunction with a web tension control system.

Further advantages and refinements of the invention emerge from the description and the appended drawing.

It goes without saying that the features mentioned above and those still to be explained below can be used not only in the respectively specified combination but also in other combinations or on their own without departing from the scope of the present invention.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows schematically the structure of a processing machine in which an embodiment of the method according to the invention can advantageously be used; and

FIG. 2 shows a flow chart of an embodiment of a method according to the invention for use for the processing machine according to FIG. 1.

### DESCRIPTION OF THE PREFERRED EMBODIMENTS

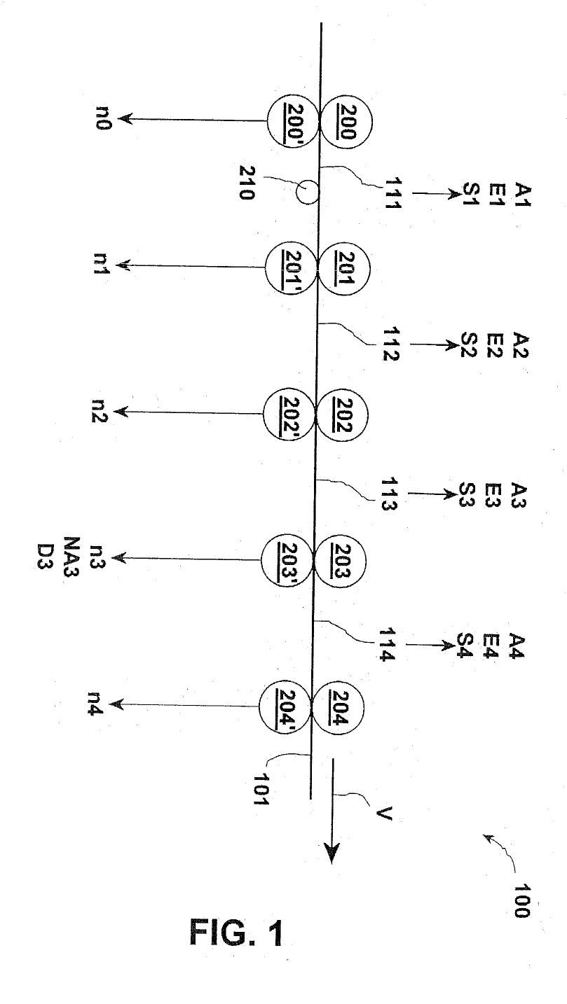

In FIG. 1, a processing machine, in which a product web 101 is subdivided into sections of different web tension, is designated overall by 100. In the processing machine 100, a product web 101 is transported and processed. For reasons of clarity, the processing devices themselves are not shown. In the present example, the product web 101 moves in the direction which is indicated by the arrow V.

As mentioned, the product web 101 is subdivided into a plurality of product web sections 111 to 114. Each product web section 111 to 114 has an actual and a desired product web tension. In each case product web cross sections A1 to A4 and moduli of elasticity E1 to E4 belong to the product web sections 111 to 114.

The product web sections 111 to 114 are delimited by the associated transport axles. For example, the product web section 111 is delimited on one side by the transport axles 200, 200′ and on the other side by the transport axles 201, 201′. The transport axles 200 to 204 are the driven transport axles, whereas the transport axles 200′ to 204′ are, for example, drive-less opposing pressure axles. The transport axles 200, 200′ rotate with a rotational speed n0, the transport axles 201, 201′ rotate with a rotational speed n1, and so on. Finally, the transport axles 204, 204′ rotate with a rotational speed n4.

Provided in the product web section 111 is a measuring device 210 for determining an absolute web tension S1 in this section. According to the solution proposed, the product web tensions in the sections 112, 113 and 114 are determined by using this first product web tension determined. No measuring devices are provided for these product web sections 112 to 114.

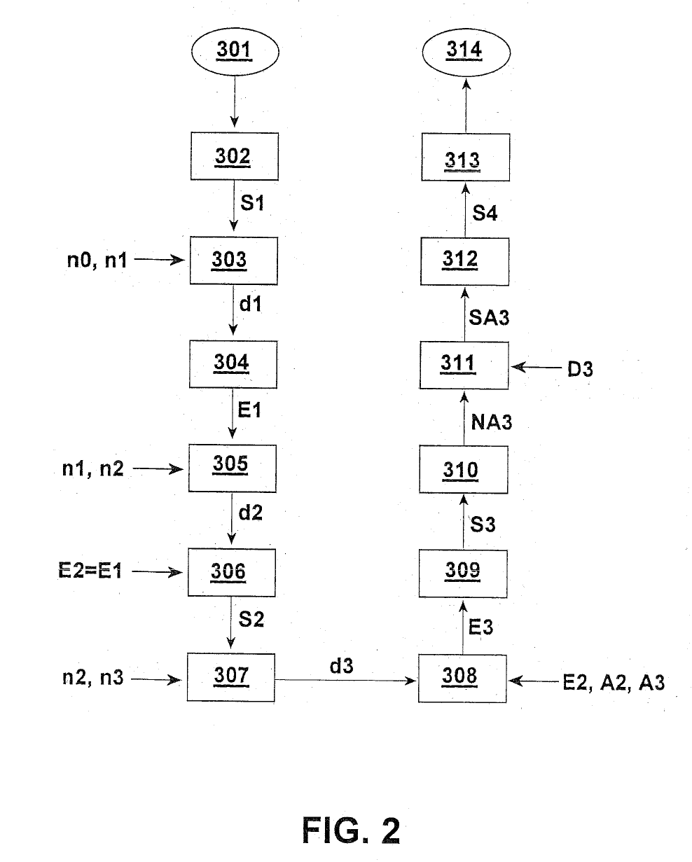

In the following text, in conjunction with FIG. 2, it will be explained how the product web tension in the individual sections 111 to 114 is determined.

The method begins in a method step 301. Then, in a step 302, the product web tension S1 in the section 111 is determined by means of the measuring device 210. By using the rotational speeds n0 and n1 of the transport axles 200, 200′, 201, 201′ delimiting the web section 111, an elongation d1 of the product web section 111 is determined in a method step 303.

From the product web tension S1 and the elongation d1 in the first product web section 111, a modulus of elasticity E1 of the product web in the section 111 is determined in a step 304.

By using the rotational speeds n1, n2 of the associated transport axles 201, . . . , 202′ an elongation d2 of the product web section 112 is determined in a step 305. Since the modulus of elasticity is not changed by the processing of the product web (not shown) performed in the product web section 112, here a modulus of elasticity E2 of the product web section 112 can be set equal to the modulus of elasticity E1 of the product web section 111. From this, in a method step 306, a product web tension S2 of the product web section 112 is determined as S2=E2×d2.

In the product web section 113, processing of the product web is carried out in such a way that a change in the product web cross section is brought about. The product web cross section A3 in the product web section 113 accordingly differs from the product web cross section A2 in the section 112.

In a method step 307, by using the rotational speeds n2 and n3 of the associated transport axles 202, . . . , 203′, an elongation d3 in the product web section 113 is determined. In a method step 308, a modulus of elasticity E3 of the product web section 113 is determined to be E3=E2×A3/A2 by using the cross sections A3 and A2 and the modulus of elasticity E2.

In a method step 309, a web tension S3 of the product web section 113 is determined as S3=E3×d3 by using the elongation d3 and the modulus of elasticity E3 of the product web section 113.

A product web tension S4 in the product web section 114 is determined by using drive torques of the relevant transport axles. In a method step 310, a drive torque NA3 of the transport axle 203 is determined for this purpose. Since a diameter D3 of the drive axle 203 is normally known from the design, in a method step 311, by means of the lever rule and by using the drive torque NA3 and the diameter D3, the web tension SA3 fed in by the drive axle 203 is determined as SA3=2NA3/D3.

Finally, in a method step 312, a web tension S4 of the product web section 114 is determined by using the product web tension S3 determined and the product web tension SA3 fed in and determined, to give S4=S3−SA3. If the transport axle 203 is working in motor operation, the result is a positive drive torque NA3; if, on the other hand, it is working in the generator range, the result is a negative drive torque NA3.

When determining the web tension by using the drive torques, it is disadvantageous that processing forces influence the web tension, frictional torques arising from non-driven guide rolls influence the web tension, frictional torques from the transport rolls influence the web tension, the measurement of the drive torque is frequently inaccurate, since the drive torque is often determined by measuring the current forming the torque and multiplying by the torque constant of the motor, in particular the knowledge of the torque constant being subject to high fabrication scatter and the measurement of the drive torque in the drive often being subject to highly fluctuating values. These disadvantages can be countered by the aforementioned developments of the method according to the invention, by which means the accuracy of this determination is improved.

In a method step 313, the actual web tension values S1 to S4 are compared with the desired web tension values. Deviations are compensated for by means known in the prior art (rotational speed change of the transport axle and so on). Therefore, the solution proposed can advantageously be used in conjunction with the regulation of web tensions.

The method ends in a step 314.

It will be understood that each of the elements described above, or two or more together, may also find a useful application in other types of methods differing from the type described above.

While the invention has been illustrated and described as embodied in a method for determining a web tension, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of determining a web tension of at least one second web tension section in a product web having at least two web tension sections, comprising the steps of determining a web tension of at least one first web tension section; and determining a web tension of the at least one second web tension section on a basis of the web tension determined on the at least one first web tension section.

2. A method as defined in claim 1, wherein said determining the web tension of the at least one first web tension section includes measuring the web tension of the at least one first web tension section.

3. A method as defined in claim 1, wherein said determining the web tension of the at least one first web tension section includes taking into account a modulus of elasticity of a material of the product web and a rotational speed of at least two transport axles.

4. A method as defined in claim 1, wherein said determining the web tension of the at least one first web tension section includes taking into account a known web tension value and a drive torque of at least one transport axle.

5. A method as defined in claim 1 wherein said determining of the web tension of the at least one second web tension section includes determining by using a rotational speed of at least two transport axles.

6. A method as defined in claim 5; and further comprising taking into account a change in an elongation property of the product web.

7. A method as defined in claim 6, wherein said taking into account the change in the elongation property includes taking into account a modulus of elasticity of the product web.

8. A method as defined in claim 7, wherein said taking into account the modulus of-elasticity includes taking into account a second cross-section of the product web in another web tension section that differs from a first cross-section of the product web in a web tension section, linearly by using a ratio of the first to the second cross-section.

9. A method as defined in claim 1; and further comprising taking into account a slip of transport axles in a manner selected from the group consisting of taking into account by estimation and taking into account the slip by estimation of the slip and taking into account the slip by measuring the slip.

10. A method as defined in claim 1, wherein said determining the web tension of the at least one second web tension section includes using a drive torque of at least one transport axle.

11. A method as defined in claim 10, wherein said using the drive torque includes converting the drive torque by a lever rule into a force changing the web section by using a diameter of the at least one transport axle.

12. A method as defined in claim 10, wherein said using a drive torque of at least one transport axle includes taking into account a frictional torque of the at least one transport axle.

13. A method as defined in claim 12, wherein said taking into account the frictional torque of the at least one transport axle includes taking into account the frictional torque with a component selected from the group consisting of a constant and a rotational speed-proportional component and a component that can be predetermined by a rotational speed-dependent characteristic curve.

14. A method as defined in claim 14, wherein said taking into account the frictional torque of the at least one transport axle includes determining the frictional torque by using a measuring run selected from the group consisting of a manual measuring run, a partly automated measuring run, and a fully automated measuring run.

15. A method as defined in claim 10, wherein said using the drive torque includes taking into account a processing torque.

16. A method as defined in claim 15, wherein said taking into account the processing torque includes taking into account the processing torque with a component selected from the group consisting of a constant and a rotational speed-proportional component and a component that can be predetermined by a rotational speed-dependent characteristic curve.

17. A method as defined in claim 10, wherein said using the drive torque includes a measurement of the drive torque carried out in a manner selected from the group consisting of filtering of measured torques, frictions determined, processing forces, and a combination thereof.

18. A method as defined in claim 10, wherein said using the drive torque includes a measurement of the drive torque; and during the measurement of the drive torque, taking into account a calibration of drive data.

19. A method as defined in claim 18, wherein said taking into account the calibration of drive data includes a calibration of a torque constant of a motor.

20. A method as defined in claim 18, wherein said taking into account the calibration of the drive data includes determining the drive data by using a parameter selected from the group consisting of a manual measuring run, a partly automated measuring run and a fully automated measuring run.

21. A method as defined in claim 10, wherein said using the drive torque includes determining the drive torque with taking into account filled-weakening operation of a motor.

22. A computing unit for determining a web tension of at least one second web tension section, comprising means for determining a web tension of at least one first web tension section; and means for determining a web tension of at least one second web tension section on the basis of the web tension determined on the at least one first web tension section.

23. A computer program having program code means in order to determine a web tension of at least one second web tension section on a basis of a web tension determined in a first web tension section according to claim 1 if the computer program is executed on a computer, or on the computing unit according to claim 22.

24. A computer program product having program code means which are stored on a computer-readable data storage medium in order to determine a web section of at least one second web tension section on a basis of a web tension determined in a first web tension section according to claim 1, if the computer program product is executed on a computer or on the computer unit according to claim 22.

25. A web tension control system configured so as to use a method according to claim 1.
